(19) United States
(12) Patent Application Publication
(10) Pub. No.: US 2022/0044545 A1
(43) Pub. Date: Feb. 10, 2022

(54) AIR-SEA BUOY MONITORING SYSTEM TOWARDS MID-LATITUDE OCEAN

(71) Applicant: OCEAN UNIVERSITY OF CHINA, Qingdao (CN)

(72) Inventors: Xin MA, Qingdao (CN); Zhaohui Chen, Qingdao (CN); Lixin Wu, Qingdao (CN); Weicheng Wang, Qingdao (CN)

(21) Appl. No.: 17/189,244

(22) Filed: Mar. 1, 2021

(30) Foreign Application Priority Data
Aug. 10, 2020 (CN) 202010795810.6

(51) Int. Cl. G08B 21/18; B63B 22/00; B63B 79/15; B63B 79/40; G01W 1/02

(52) U.S. Cl. CPC G08B 21/182; B63B 22/00; G01W 1/02; B63B 79/40; B63B 79/15

(57) ABSTRACT

The present invention discloses an air-sea buoy monitoring system towards mid-latitude ocean including a meteorological data acquisition system, an underwater data acquisition system and a central processor. It collects data through different sensors via both meteorology and underwater data acquisition systems, and then transmits data to a central processor. The data collected by meteorology and underwater data acquisition systems will be analyzed and visualized via an information processing system and an image processing system. An alarm module is provided to alarm when meteorological data/value exceeds a certain threshold. This buoy monitoring system ensures the long term, continuous and simultaneous observation of multi-level/multi-factors for the air-sea interface and underwater oceanic environment at a fixed point, with the data being transmitted to shore-based data center in real time via communication satellites.

### TECHNICAL FIELD

The present invention relates to the technical field of ocean monitoring, in particular, an air-sea buoy monitoring system towards mid-latitude ocean.

### BACKGROUND ART

Marine environment refers to the total waters of vast and continuous seas and oceans on the earth, including seawater, dissolved and suspended materials in the seawater, sediments and marine organisms. It is the cradle of life and the resources repository for mankind. The ocean, which is now impacted by warming, acidification, de-oxygenation and pollution, needs improvement of its current conditions.

In recent years, human activities are gradually affected by marine and metrological environments on the earth. People can well predict the meteorological variability and trends with the help of satellite communications, remote sensing and other state-of-the-art technologies. However, few observatories are currently on site in the open ocean, leading to obstacle of testing the reliability and accuracy of numerical predictions. Furthermore, understanding of the basic characteristics of metrological/oceanic variables like wind speed, direction, air pressure, ocean currents as well as the real-time conditions is crucial to marine navigation, in particular, safe and economic navigation for shipping companies. The current ocean monitoring systems, however, are not capable of monitoring of air-sea interface and underwater ocean dynamic environment in effective ways.

Therefore, it is quite necessary to invent an air-sea buoy monitoring system under harsh conditions in the mid-latitude of global ocean to better tackle with the problems mentioned above.

### SUMMARY OF THE INVENTION

The object of the present invention is to provide an air-sea buoy monitoring system towards mid-latitude ocean. It collects data through different sensors via both meteorology and underwater data acquisition systems, and then transmits data to a central processor. The data collected by meteorology and underwater data acquisition systems will be analyzed and visualized via an information processing system and an image processing system. An alarm module is provided to alarm when meteorological data/value exceeds a certain threshold. This buoy monitoring system ensures the long term, continuous and simultaneous observation of multi-level/multi-factors for the air-sea interface and underwater oceanic environment at a fixed point, with the data being transmitted to shore-based data center in real time via communication satellites.

In order to achieve the above-mentioned object, the present invention provides a technical solution as follows: an air-sea buoy monitoring system towards mid-latitude ocean, including a meteorological data acquisition system, an underwater data acquisition system and a central processor, wherein: the meteorological data acquisition system is used for collecting the meteorological information of air-sea interface and for transmitting the collected information to the central processor for processing; the underwater data acquisition system is used for collecting information of the underwater marine dynamic environment and for transmitting the collected information to the central processor for processing; output ends ofthe meteorological data acquisition system and the underwater data acquisition system are both connected to an input end of the central processor; the central processor is provided with an information processing system used for analyzing and visualizing data information collected by the meteorological data acquisition system and the underwater data acquisition system, and an image processing system used for visualization of the data information analyzed and visualized by the information processing system; an output end of the central processor is provided with an alarm module to alarm when the meteorological monitoring information exceeds a threshold value; an output end of the alarm module is provided with a power module used for supplying power to parts and components inside of the meteorology monitoring system, and an output end of the power module is provided with a controller for controlling on-off of the whole meteorology monitoring system.

Preferably, the meteorological data acquisition system includes a humidity sensor, a first temperature sensor, a wind speed sensor, a wind direction sensor, an air pressure sensor, a gas content sensor and a brightness sensor, wherein the humidity sensor, the first temperature sensor, the air pressure sensor and the gas content sensor are used for monitoring temperature, humidity, air pressure and some gas contents in the air of the air-sea interface, and for transmitting monitored data information into the central processor for processing.

Preferably, the wind speed sensor and the wind direction sensor are used for monitoring wind speed and wind direction of the air-sea interface, and the brightness sensor is used for monitoring atmosphere visibility of the air-sea interface and for transmitting monitored data information into the central processor for processing.

Preferably, the underwater data acquisition system includes a pressure sensor, a range sensor, a second temperature sensor, a seawater salinity sensor, an ocean current sensor and a visibility sensor, wherein the pressure sensor, the second temperature sensor, the seawater salinity sensor and the ocean current sensor are used for monitoring pressure, temperature, seawater salinity and a current speed of seawater in the underwater marine dynamic environment, and for transmitting monitored data information into the central processor for processing.

Preferably, the range sensor and the visibility sensor are used for monitoring visibility in the underwater marine dynamic environment of different depths, and for transmitting monitored data information into the central processor for processing.

Preferably, the information processing system includes a data receiving module, a data processing module, a data comparison module and a data transmission module, wherein: the data processing module and the data comparison module are used for processing and comparing all monitored data information received by the data receiving module, and the data transmission module is used for transmitting processed data information to the image processing system for visualization.

Preferably, the image processing system includes an image processing module, an image storage module and an image display module, wherein: the image processing module and the image storage module are used for analyzing and visualizing data information transmitted by the data transmission module, and the image display module is used for visualization of analyzed and visualized data information.

The present invention, which includes the above technical solutions, provides effects and advantages as follows:

data are collected through different sensors via both meteorology and underwater data acquisition systems, and then are transmitted to a central processor. The data will be analyzed and visualized via an information processing system and an image processing system. An alarm module is provided to alarm when the meteorological value exceeds a certain threshold. The buoy monitoring system ensures the long term, continuous and simultaneous observation of multi-level/multi-factors for the air-sea interface and underwater oceanic environment at a fixed point, with the data being transmitted to shore-based data center in real time via communication satellites.

### DESCRIPTION OF DRAWINGS

In order to make the examples of the present application or the technical solutions of prior arts clearer, drawings to be used in the examples are simply explained below. Obviously, the drawings described below are merely some examples disclosed in the present invention, and ordinary technicians in this field can also obtain other drawings based on these ones.

FIG. 1 is an overall structure diagram of the present invention;

FIG. 2 is a structure diagram of the meteorological data acquisition system of the present invention; and

FIG. 3 is a structure diagram of the underwater data acquisition system of the present invention.

### DESCRIPTION OF REFERENCE MARKS

1. Meteorological data acquisition system; 2. Underwater data acquisition system; 3. Central processor; 4. Information processing system; 5. Image processing system; 6. Alarm module; 7. Power module; 8. Controller; 9. Humidity sensor; 10. First temperature sensor; 11. Wind speed sensor; 12. Wind direction sensor; 13. Air pressure sensor; 14. Gas content sensor; 15. Brightness sensor; 16. Pressure sensor; 17. Range sensor; 18. Second temperature sensor; 19. Seawater salinity sensor; 20. Ocean current sensor; 21. Visibility sensor; 22. Data receiving module; 23. Data processing module; 24. Data comparison module; 25. Data transmission module; 26. Image processing module; 27. Image storage module; 28. Image display module.

### Embodiments

For better understanding of the technical solution of the present invention by one skilled in the art, the present invention will be further elaborated as below with reference to the drawings.

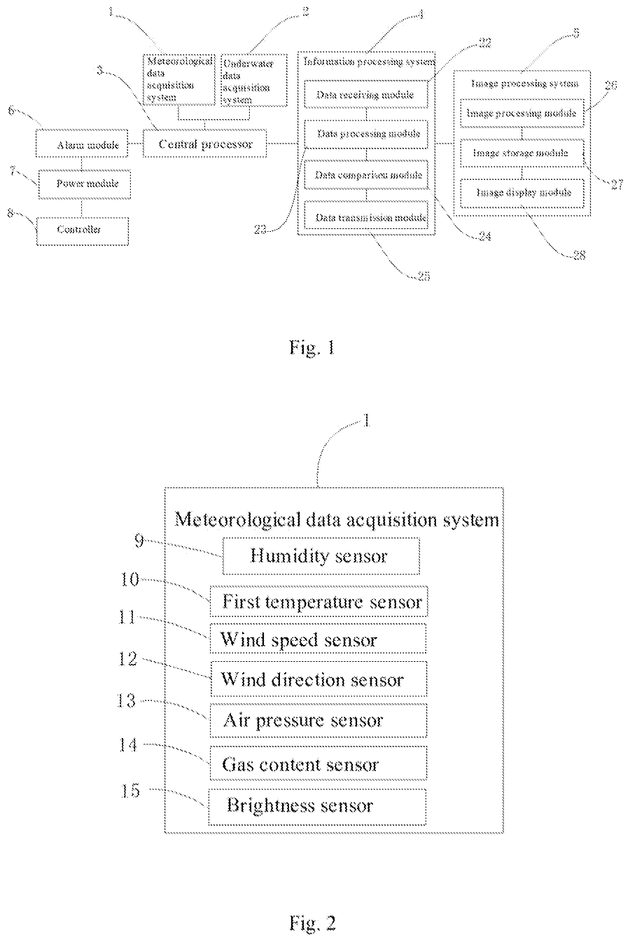

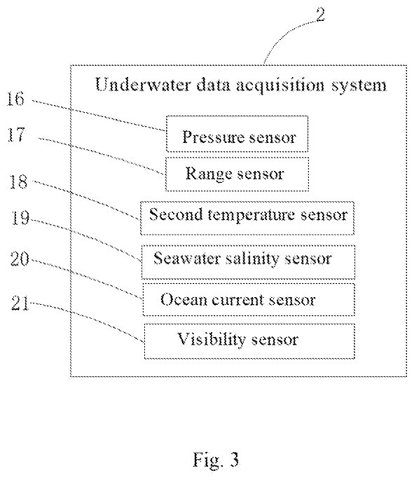

The present invention provides an air-sea buoy monitoring system towards mid-latitude ocean shown in FIG. 1-3 including a meteorological data acquisition system 1, an underwater data acquisition system 2 and a central processor 3, wherein: the meteorological data acquisition system 1 is used for collecting the meteorological information of air-sea interface and for transmitting the collected information to the central processor 3 for processing; the underwater data acquisition system 2 is used for collecting information of the underwater marine dynamic environment and for transmitting the collected information to the central processor 3 for processing; output ends of the meteorological data acquisition system 1 and the underwater data acquisition system 2 are both connected to an input end of the central processor 3; the central processor 3 is provided with an information processing system 4 used for analyzing and visualizing data information collected by the meteorological data acquisition system 1 and the underwater data acquisition system 2, and an image processing system 5 used for visualization of the data information analyzed and visualized by the information processing system 4; an output end of the central processor 3 is provided with an alarm module 6 used for performing early warning for the meteorological monitoring information exceeding a threshold value; and an output end of the alarm module 6 is provided with a power module 7 used for supplying power to parts and components inside of the meteorology monitoring system, and an output end of the power module 7 is provided with a controller 8 for controlling on-off of the whole meteorology monitoring system.

Further, in the above technical solution, the meteorological data acquisition system 1 includes a humidity sensor 9, a first temperature sensor 10, a wind speed sensor 11, a wind direction sensor 12, an air pressure sensor 13, a gas content sensor 14 and a brightness sensor 15, wherein the humidity sensor 9, the first temperature sensor 10, the air pressure sensor 13 and the gas content sensor 14 are used for monitoring temperature, humidity, air pressure and some gas contents in the air of the air-sea interface, and for transmitting monitored data information into the central processor 3 for processing.

Further, in the above technical solution, the wind speed sensor 11 and the wind direction sensor 12 are used for monitoring wind speed and wind direction of the air-sea interface, and the brightness sensor 15 is used for monitoring atmosphere visibility of the air-sea interface and for transmitting monitored data information into the central processor 3 for processing.

Further, in the above technical solution, the underwater data acquisition system 2 includes a pressure sensor 16, a range sensor 17, a second temperature sensor 18, a seawater salinity sensor 19, an ocean current sensor 20 and a visibility sensor 21, wherein: the second temperature sensor 18, the seawater salinity sensor 19 and the ocean current sensor 20 are used for monitoring pressure, temperature, seawater salinity and a current speed of seawater in the underwater marine dynamic environment, and for transmitting monitored data information into the central processor 3 for processing, the pressure sensor 16, the range sensor 17; and the visibility sensor 21 are used for monitoring visibility in the underwater marine dynamic environment of different depths, and for transmitting monitored data information into the central processor 3 for processing.

Further, in the above technical solution, the information processing system 4 includes a data receiving module 22, a data processing module 23, a data comparison module 24 and a data transmission module 25, wherein: the data receiving module 22 is used for receiving and transmitting data information, monitored and transmitted by all sensors in the meteorological data acquisition system 1 and the underwater data acquisition system 2, to the data processing module 23 and the data comparison module 24 for subsequent processing; the data processing module 23 and the data comparison module 24 are used for processing and comparing all data collected by the data receiving module 22, and the data transmission module 25 is used for transmitting processed data information to the image processing system 5 for visualization.

Further, in the above technical solution, the image processing system 5 includes an image processing module 26, an image storage module 27 and an image display module 28, wherein: the image processing module 26 and the image storage module 27 are used for analyzing and visualizing data information transmitted by the data transmission module 25, and the image display module 28 is used for visualization of analyzed and visualized data information.

With reference to FIGS. 1-3, when the present invention is used, plural different sensors in the meteorological data acquisition system 1 and the underwater data acquisition system 2 transmit all monitored data information into the central processor 3 for processing; the information processing system 4 analyzes and visualizes data information collected by the meteorological data acquisition system 1 and the underwater data acquisition system 2, and the image processing system 5 performs visualization for the analyzed and visualized data information, and then the alarm module 6 alarms when meteorological monitoring information exceeds a threshold value, thereby realizing effective monitoring of information for both the air-sea interface and the underwater marine dynamic environment.

Above merely illustrates some exemplary examples of the present invention. There is no doubt that ordinary technicians in this field can modify the illustrated examples in various ways without deviating from the spirits and scope of the present invention. Therefore, the above drawings and description are substantively illustrative, and should not be understood as limits on the protection scope of the claims of the present invention.

1. An air-sea buoy monitoring system towards mid-latitude ocean including a meteorological data acquisition system (1), an underwater data acquisition system (2) and a central processor (3), wherein: the meteorological data acquisition system (1) is used for collecting the meteorological information of air-sea interface, and for transmitting the collected information to the central processor (3) for processing; the underwater data acquisition system (2) is used for collecting information of the underwater marine dynamic environment, and for transmitting the collected information to the central processor (3) for processing; output ends of the meteorological data acquisition system (1) and the underwater data acquisition system (2) are both connected to an input end of the central processor (3); the central processor (3) is provided with an information processing system (4) used for analyzing and visualizing data information collected by the meteorological data acquisition system (1) and the underwater data acquisition system (2), and an image processing system (5) used for visualization of the data information analyzed and visualized by the information processing system (4); an output end of the central processor (3) is provided with an alarm module (6) for performing early warning for the meteorological monitoring information exceeding a threshold value; an output end of the alarm module (6) is provided with a power module (7) used for supplying power to parts and components inside of the meteorology monitoring system; and an output end of the power module (7) is provided with a controller (8) for controlling on-off of the whole meteorology monitoring system.

2. The air-sea buoy monitoring system towards mid-latitude ocean according to claim 1, wherein: the meteorological data acquisition system (1) includes a humidity sensor (9), a first temperature sensor (10), a wind speed sensor (11), a wind direction sensor (12), an air pressure sensor (13), a gas content sensor (14) and a brightness sensor (15), wherein the humidity sensor (9), the first temperature sensor (10), the air pressure sensor (13) and the gas content sensor (14) are used for monitoring temperature, humidity, air pressure and some gas contents in the air of the air-sea interface, and for transmitting monitored data information into the central processor (3) for processing.

3. The air-sea buoy monitoring system towards mid-latitude ocean according to claim 2, wherein: the wind speed sensor (11) and the wind direction sensor (12) are used for monitoring wind speed and wind direction of the air-sea interface; and the brightness sensor (15) is used for monitoring atmosphere visibility of the air-sea interface and for transmitting monitored data information into the central processor (3) for processing.

4. The air-sea buoy monitoring system towards mid-latitude ocean according to claim 1, wherein: the underwater data acquisition system (2) includes a pressure sensor (16), a range sensor (17), a second temperature sensor (18), a seawater salinity sensor (19), an ocean current sensor (20) and a visibility sensor (21), the pressure sensor (16), the second temperature sensor (18), the seawater salinity sensor (19) and the ocean current sensor (20) being used for monitoring pressure, temperature, seawater salinity and a current speed of seawater in the underwater marine dynamic environment, and for transmitting monitored data information into the central processor (3) for processing.

5. The air-sea buoy monitoring system towards mid-latitude ocean according to claim 4, wherein: the range sensor (17) and the visibility sensor (21) are used for monitoring visibility in the underwater marine dynamic environment of different depths, and for transmitting monitored data information into the central processor (3) for processing.

6. The air-sea buoy monitoring system towards mid-latitude ocean according to claim 1, wherein: the information processing system (4) includes a data receiving module (22), a data processing module (23), a data comparison module (24) and a data transmission module (25), the data processing module (23) and the data comparison module (224) being used for processing and comparing all monitored data information received by the data receiving module (22), and the data transmission module (25) being used for transmitting processed data information to the image processing system (5) for visualization.

7. The air-sea buoy monitoring system towards mid-latitude ocean according to claim 1, wherein: the image processing system (5) includes an image processing module (26), an image storage module (27) and an image display module (28), the image processing module (26) and the image storage module (27) being used for analyzing and visualizing data information transmitted by the data transmission module (25), and the image display module (28) being used for visualization of analyzed and visualized data information.
